(19) United States
(12) Patent Application Publication
(10) Pub. No.: US 2026/0052535 A1
(43) Pub. Date: Feb. 19, 2026

(54) UCI MULTIPLEXING ON SIMULTANEOUS PUSCH TRANSMISSIONS OVER MULTIPLE PANELS

(71) Applicant: Apple Inc., Cupertino, CA (US)

(72) Inventors: Seyed Ali Akbar Fakoorian, San Diego, CA (US); Haitong Sun, Cupertino, CA (US); Hong He, San Jose, CA (US); Huaning Niu, San Jose, CA (US); Wei Zeng, Saratoga, CA (US)

(21) Appl. No.: 19/103,136

(22) PCT Filed: Jul. 20, 2023
(86) PCT No.: PCT/US2023/028209

§ 371 Date: Feb. 11, 2025

Related U.S. Application Data
(60) Provisional application No. 63/397,743, filed on Aug. 12, 2022.

(51) Int. Cl. H04W 72/21; H04B 7/06

(52) U.S. Cl. CPC H04W 72/21; H04B 7/06956

(57) ABSTRACT

Disclosed is a method is performed by a user equipment (UE). The method includes configuring a physical uplink shared channel (PUSCH) transmission that comprises a first resource associated with a first antenna panel and a second resource associated with a second antenna panel, wherein the first antenna panel is directed toward a first transmission/reception point (TRP) and the second antenna panel is directed toward a second TRP. The method also includes determining that the PUSCH transmission overlaps in time with a physical uplink control channel (PUCCH) transmission toward at least one of the first TRP or the second TRP. The method also includes multiplexing uplink control information (UCI) associated with the PUCCH transmission on the PUSCH transmission.

### CROSS REFERENCE TO RELATED APPLICATIONS

This application claims priority to U.S. Provisional Patent Application No. 63/397,743, filed Aug. 12, 2022, the content of which is incorporated hereby by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

Some wireless communication networks support multiple transmission/reception point (TRP) (multi-TRP or m-TRP) operation. In these networks, one or more base stations may act as or otherwise utilize multiple TRPs to communicate with a user equipment (UE). To facilitate multi-TRP operation, the TRPs and the UE can each include multiple antenna panels, with each panel having multiple antenna elements or beams. A UE that includes multiple antenna panels is referred to as a multi-panel UE.

### SUMMARY

In accordance with one aspect of the present disclosure, a method performed by a UE is disclosed. The method includes configuring a physical uplink shared channel (PUSCH) transmission that comprises a first resource associated with a first antenna panel and a second resource associated with a second antenna panel, wherein the first antenna panel is directed toward a first TRP and the second antenna panel is directed toward a second TRP. The method also includes determining that the PUSCH transmission overlaps in time with a physical uplink control channel (PUCCH) transmission toward at least one of the first TRP or the second TRP. The method also includes multiplexing uplink control information (UCI) associated with the PUCCH transmission on the PUSCH transmission.

In some implementations, the PUSCH transmission is configured by downlink control information (DCI) received from one of the first TRP and the second TRP.

In some implementations, multiplexing the UCI on the PUSCH transmission includes determining that the PUCCH transmission is directed toward the first TRP, and responsive to the determination, multiplexing the UCI on the first resource.

In some implementations, the PUCCH transmission includes a first repetition transmitted over the first resource and a second repetition transmitted over the second resource.

In some implementations, the method also includes calculating a code rate for UCI multiplexing based on resource elements (REs) associated with the first resource.

In some implementations, the method also includes calculating a code rate for UCI multiplexing based on REs associated with the first resource and REs associated with the second resource.

In some implementations, the method also includes multiplexing the UCI on the second resource.

In some implementations, the method also includes calculating a code rate for UCI multiplexing based on REs associated with the first resource and REs associated with the second resource.

In some implementations, the PUCCH transmission is directed toward both the first TRP and the second TRP, and the UCI is multiplexed on a combination of the first resource and the second resource.

In some implementations, the method also includes calculating a code rate for UCI multiplexing based on REs associated with the first resource and REs associated with the second resource.

In some implementations, after determining that the PUSCH transmission overlaps in time with the PUCCH transmission, the method also includes configuring the PUSCH transmission or the PUCCH transmission such that the PUSCH transmission no longer overlaps in time with the PUCCH transmission.

In some implementations, the first resource and the second resource are configured for a single frequency network (SFN).

In some implementations, the first resource and the second resource are spatial division multiplexed (SDM-ed).

In some implementations, multiplexing the UCI on the PUSCH transmission is based on UE capability or radio resource control (RRC) signaling.

In accordance with one aspect of the present disclosure, a processor comprising circuitry is disclosed. The circuitry executes one or more instructions that cause a UE to perform operations. The operations include configuring a PUSCH transmission that comprises a first resource associated with a first antenna panel and a second resource associated with a second antenna panel, wherein the first antenna panel is directed toward a first TRP and the second antenna panel is directed toward a second TRP. The operations also include determining that the PUSCH transmission overlaps in time with a PUCCH transmission toward at least one of the first TRP or the second TRP. The operations also include multiplexing UCI on the PUSCH transmission.

In accordance with one aspect of the present disclosure, a non-transitory computer-readable medium containing program instructions is disclosed. The program instructions are configured to cause a processor to perform operations. The operations include configuring a PUSCH transmission that comprises a first resource associated with a first antenna panel and a second resource associated with a second antenna panel, wherein the first antenna panel is directed toward a first TRP and the second antenna panel is directed toward a second TRP. The operations also include determining that the PUSCH transmission overlaps in time with a PUCCH transmission toward at least one of the first TRP or the second TRP. The operations also include multiplexing UCI on the PUSCH transmission.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2A illustrates the scheduling of PUSCH transmission based on the FDM scheme, according to some implementations.

FIG. 2B illustrates the scheduling of PUSCH transmission based on the SDM scheme, according to some implementations.

FIG. 2C illustrates the scheduling of PUSCH transmission on resources that partially overlap in frequency, according to some implementations.

FIG. 3 illustrates an example mechanism for UCI multiplexing, according to some implementations.

FIG. 4 illustrates an example mechanism for UCI multiplexing, according to some implementations.

FIG. 5 illustrates an example mechanism for UCI multiplexing, according to some implementations.

FIG. 6 illustrates a flowchart of an example method for UCI multiplexing, according to some implementations.

FIG. 7 illustrates a UE, according to some implementations.

FIG. 8 illustrates an access node, according to some implementations.

### DETAILED DESCRIPTION

A UE can transmit uplink (UL) signals to a TRP via a physical uplink shared channel (PUSCH). For multi-panel UEs communicating with multiple TRPs, the PUSCH transmission can be multiplexed on resources associated with multiple antenna panels directed toward the multiple TRPs. For example, the UE can generate a sequence of modulated PUSCH transport blocks (TBs), use an FDM scheme or SDM scheme to divide the TBs across resources, and then simultaneously transmit the TBs using the two antenna panels toward two TRPs. In addition, some UEs implementing the FDM scheme support PUSCH transmission with repetitions, where the same sequence of PUSCH TBs are transmitted as repetitions using multiple antenna panels. An FDM scheme with repetitions is referred to as FDM Type B (FDM-B), while an FDM scheme without repetitions is referred to as FDM Type A (FDM-A). Parameters for scheduling and multiplexing the PUSCH transmission can be configured by, e.g., DCI received from one or more of the multiple TRPs. In single-DCI mode where the PUSCH transmission is configured by a single DCI, the DCI can schedule the PUSCH transmission over multiple antenna panels toward the multiple TRPs.

In some scenarios, the PUSCH transmission may overlap in time with a physical uplink control channel (PUCCH) transmission toward one or more of the multiple TRPs. Further, a PUCCH transmission is typically accompanied by UCI that needs to be transmitted using one or more antenna panels. Thus, the overlap between PUCCH and PUSCH calls for a mechanism for multiplexing the UCI on the PUSCH. However, existing 3GPP specifications do not support transmissions of PUCCH and PUSCH that overlap in time, and, consequently, do not provide such a mechanism. This can possibly lead to communication failures as existing networks are not configured to properly handle UCI multiplexing in such scenarios.

This disclosure provides one or more mechanisms for multiplexing UCI on a PUSCH transmission using multiple antenna panels. With the features provided herein, a multi-panel UE can properly conduct simultaneous PUSCH and PUCCH transmissions toward multiple TRPs, thereby improving communication reliability and efficiency. For the purpose of this disclosure, the number of panels is assumed to be two and the number of TRPs is also assumed to be two, although these numbers are not limiting in the implementations of the disclosure.

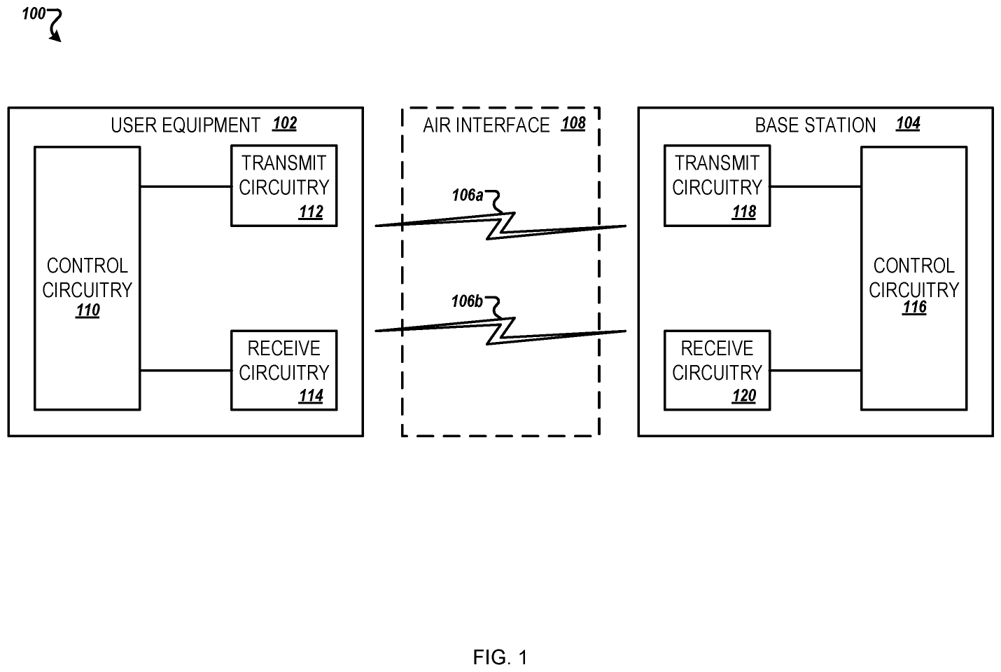

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

Additionally, the transmit circuitry 112 may transmit a plurality of multiplexed uplink physical channels. The plurality of uplink physical channels may be multiplexed according to TDM or FDM along with carrier aggregation. The transmit circuitry 112 may be configured to receive block data from the control circuitry 110 for transmission across the air interface 108.

Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

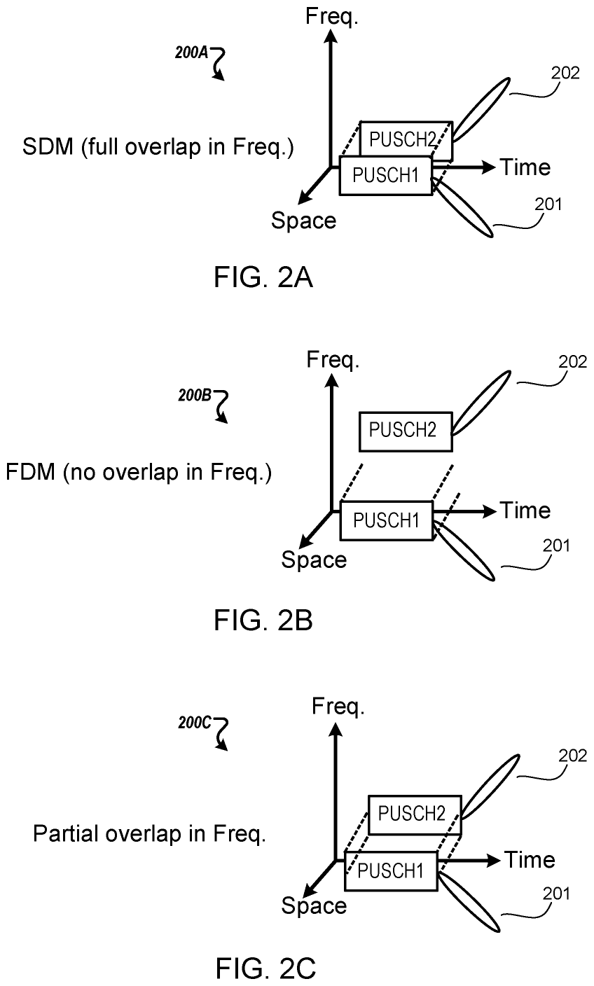

As previously discussed, for a UE with two panels communicating with two TRPs, the UE can schedule the PUSCH transmission on resources associated with the two panels. For example, some TBs of the PUSCH transmission are scheduled on a resource associated with a first panel. The first panel then transmits a beam carrying these TBs to a TRP corresponding to the first panel. Similarly, some TBs of the PUSCH transmission are scheduled on a resource associated with a second panel, which then transmits another beam carrying the TBs to a TRP corresponding to the second panel. The transmission of TBs using the first panel is referred to as PUSCH1, while the transmission of TBs using the second panel is referred to as PUSCH2. For PUSCH1 and PUSCH2 to occur simultaneously, they can be scheduled on resources based on an FDM scheme or an SDM scheme. Example scheduling schemes are illustrated in FIGS. 2A-2C.

FIG. 2A illustrates the scheduling 200A of PUSCH transmission based on the SDM scheme, according to some implementations. In FIG. 2A, the PUSCH transmission includes PUSCH1 and PUSCH2, which are scheduled to occur during the same time period. Under the SDM scheme of FIG. 2A, PUSCH1 and PUSCH2 fully overlap in frequency and are spatially divided on two panels 201 and 202. Each panel transmits a beam toward a corresponding TRP (not illustrated).

FIG. 2B illustrates the scheduling 200B of PUSCH transmission based on the FDM scheme, according to some implementations. In FIG. 2B, the PUSCH transmission includes PUSCH1 and PUSCH2, which are scheduled to occur during the same time period. Under the FDM scheme of FIG. 2B, PUSCH1 and PUSCH2 do not overlap in frequency but are multiplexed on different frequency bands. PUSCH1 and PUSCH2 are then transmitted by the two panels 201 and 202 toward corresponding TRPs (not illustrated). If the scheme is FDM-A, then the TBs in PUSCH1 and PUSCH2 are not repetitions but together form the entire PUSCH transmission. If the scheme is FDM-B, then the TBs in PUSCH1 and PUSCH2 are identical.

FIG. 2C illustrates the scheduling 200C of PUSCH transmission on resources that partially overlap in frequency, according to some implementations. In FIG. 2C, the PUSCH transmission includes PUSCH1 and PUSCH2, which are scheduled to occur during the same time period. PUSCH1 and PUSCH2 in FIG. 2C partially overlap in frequency and are scheduled to transmit by the two panels 201 and 202 toward corresponding TRPs (not illustrated). Scheme 200C can be regarded as a combination of SDM and FDM.

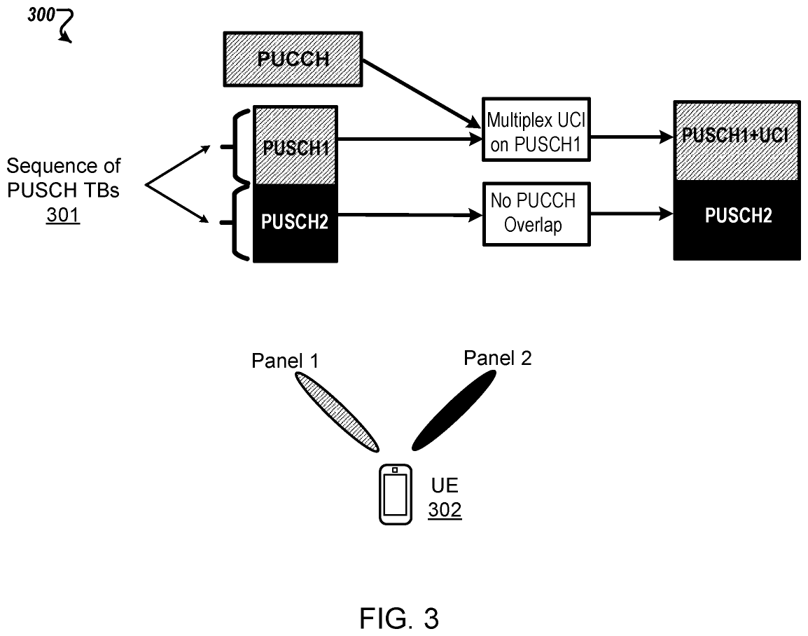

In some scenarios, the PUSCH transmission can overlap in time with a PUCCH transmission. Specifically, while a UE is scheduled under any of schemes 200A-200C to simultaneously transmit PUSCH1 and PUSCH2 to two TRPs, the UE can also be scheduled to perform a PUCCH transmission toward either or both of the two TRPs. When the PUCCH resource overlaps either or both of the PUSCH1 and PUSCH2 resources, a potential conflict (“collision”) between PUCCH and PUSCH transmissions could arise. To avoid the potential collision, the UE, in some implementations, can multiplex UCI accompanying the PUCCH transmission on the PUSCH transmission. Example implementations for UCI multiplexing are described below with reference to FIGS. 3-5.

FIG. 3 illustrates an example mechanism 300 for UCI multiplexing, according to some implementations. As shown in FIG. 3, mechanism 300 is implemented by multi-panel UE 302, which has two panels, Panel 1 and Panel 2. Multi-panel UE 302 can be structurally or functionally implemented in the same way as UE 102 of FIG. 1.

In the example of FIG. 3, multi-panel UE 302 is configured to transmit a sequence of PUSCH TBs 301. PUSCH TBs 301 are divided into PUSCH1 for transmission on Panel 1 and PUSCH2 for transmission on Panel 2. Panel 1 and Panel 2 will each transmit a beam toward a corresponding TRP.

In this example, multi-panel UE 302 is also configured to perform a PUCCH transmission. The PUCCH transmission is scheduled for transmission on Panel 1 only, as illustrated by the shading in FIG. 3. Therefore, the PUCCH transmission overlaps in time with the resource for PUSCH1 but does not overlap in time with the resource for PUSCH2. The overlap between PUCCH and PUSCH1 could lead to a collision of resources in scheduling. To avoid the collision, multi-panel UE 302 multiplexes UCI on the PUSCH transmission.

In some implementations, the multi-panel UE 302 multiplexes the UCI only on PUSCH1. That is, the multi-panel UE 302 multiplexes the UCI only on the PUSCH resource that overlaps the PUCCH transmission (the resource associated with Panel 1 in this example). As a result, Panel 1 will transmit TBs of PUSCH1 and the UCI. On the other hand, Panel 2 will transmit TBs of PUSCH2 without UCI.

Mechanism 300 can apply to scenarios where PUSCH1 and PUSCH2 are scheduled according to the FDM-A scheme. Because only one panel (Panel 1 in mechanism 300) has UCI multiplexed thereon, mechanism 300 is similar to UCI multiplexing where PUSCH1 and PUSCH2 are repetitions under the FDM-B scheme. In the FDM-B scheme, UCI multiplexing can be done on each repetition, i.e., on a per-panel basis. In addition to applying to the FDM-A scheme, mechanism 300 can apply to scenarios where PUSCH1 and PUSCH2 are scheduled according to the SDM scheme.

In some implementations, mechanism 300 involves network 100 calculating the code rate for UCI multiplexing. Code rate indicates a ratio between information bits and total bits transmitted. A step of code rate calculation can be determining which REs to be considered in the calculation. According to some implementations, the calculation of code rate in mechanism 300 considers REs associated with the PUSCH1 resource only, without considering REs associated with the PUSCH2 resource. According to some alternative implementations, the calculation of code rate in mechanism 300 considers both REs associated with the PUSCH1 resource and REs associated with the PUSCH2 resource.

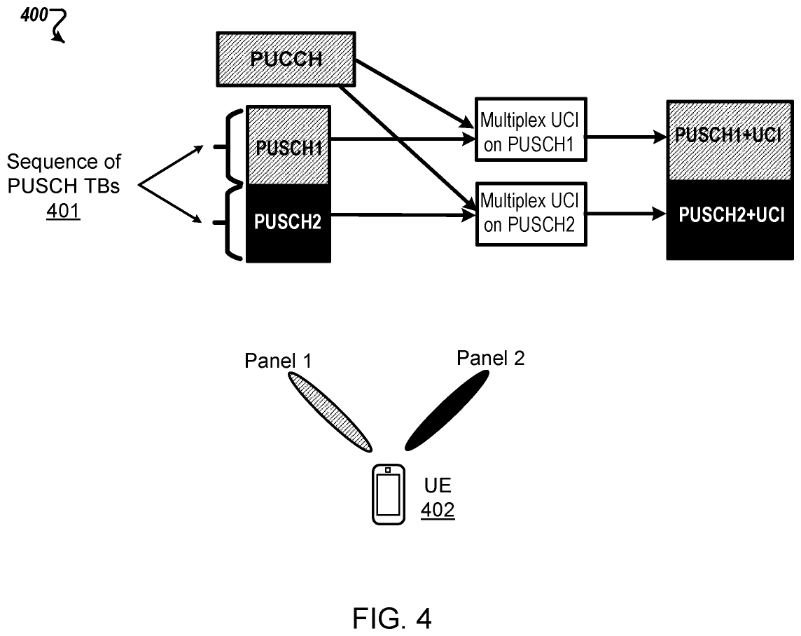

FIG. 4 illustrates an example mechanism 400 for UCI multiplexing, according to some implementations. As shown in FIG. 4, mechanism 400 is implemented by multi-panel UE 402, which has two panels, Panel 1 and Panel 2. UE 402 can be structurally or functionally implemented in the same way as UE 102 of FIG. 1.

Similar to the example of FIG. 3, UE 402 is configured to transmit a sequence of PUSCH TBs 401, which are divided into PUSCH1 to be transmitted on Panel 1 and PUSCH2 to be transmitted Panel 2. Meanwhile, UE 302 is configured to perform a PUCCH transmission that overlaps in time with the resource for PUSCH1 but does not overlaps in time with the resource for PUSCH2.

In some implementations, UE 302 multiplexes UCI on both PUSCH1 and PUSCH2. That is, UE 302 multiplexes UCI both on (i) the PUSCH resource that overlaps the PUCCH transmission (the resource associated with Panel 1 in this example) and on (ii) the PUSCH resource that does not overlap the PUCCH transmission (the resource associated with Panel 2 in this example). As a result, Panel 1 will transmit TBs of PUSCH1 along with multiplexed UCI, and Panel 2 will transmit TBs of PUSCH2 with multiplexed UCI.

Similar to mechanism 300, mechanism 400 can apply to scenarios where PUSCH1 and PUSCH2 are scheduled according to the FDM-A scheme or the SDM scheme. Also similar to mechanism 300, mechanism 400 can involve calculating the code rate for UCI multiplexing. According to some implementations, the calculation of code rate in mechanism 400 considers both REs associated with the PUSCH1 resource and REs associated with the PUSCH2 resource.

In some implementations, UE 302 can select whether to follow mechanism 300 or mechanism 400 in multiplexing UCI. If selecting mechanism 300, UE 302 can further select which of the two alternative code rate calculations to use for code rate calculation. These selections can be based on, e.g., a capability of UE 302, or RRC signaling that UE 302 receives from a network, such as network 100 in FIG. 1.

In some implementations, UE 302 can apply mechanism 300 or mechanism 400 to a SFN in a manner similar to the SDM scheme. For example, UE 302 can configure resources for both PUSCH1 and PUSCH2 in the same frequency channel while multiplexing PUSCH1 and PUSCH2 transmission according to mechanism 300 or mechanism 400. Different from the SDM scheme where panels 1 and 2 can be used to transmit different information, UE 302 transmits the same information on panels 1 and 2 when applying a multiplexing scheme to a SFN.

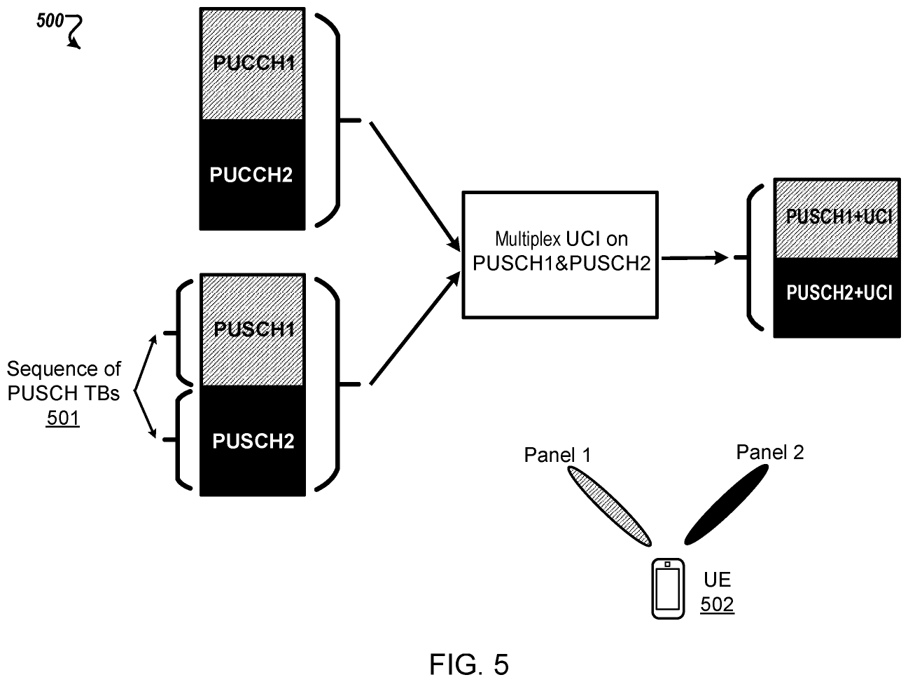

FIG. 5 illustrates an example mechanism 500 for UCI multiplexing, according to some implementations. Mechanism 500 can be implemented by multi-panel UE 502, which can be structurally or functionally the same as UE 102 of FIG. 1. Different from mechanisms 300 and 400 where the PUCCH transmission overlaps with resource of only one of PUSCH1 and PUSCH2, mechanism 500 applies to scenarios where the PUCCH transmission overlaps with resources of both PUSCH1 and PUSCH2. That is, the PUCCH transmission in mechanism 500 is divided into PUCCH1 and PUCCH2, which are respectively associated with Panel 1 and Panel 2 of UE 502 toward corresponding TRPs. Therefore, Panel 1 faces a potential collision between PUSCH1 and PUCCH1, and Panel 2 faces a potential collision between PUSCH2 and PUCCH2.

To avoid the potential collisions, in some implementations, UE 302 multiplexes UCI on the whole PUSCH resource, i.e., a combination of on PUSCH1 and PUSCH2 resources. That is, a part of UCI is multiplexed on the PUSCH1 resource (the resource associated with Panel 1 in this example) and a part of UCI is multiplexed on the PUSCH2 resource (the resource associated with Panel 2 in this example). As a result, Panel 1 will transmit TBs of PUSCH1 along with a part of UCI, and Panel 2 will transmit TBs of PUSCH2 with another part of UCI.

Similar to mechanisms 300 and 400, mechanism 500 can involve calculating the code rate for UCI multiplexing. According to some implementations, the calculation of code rate in mechanism 500 considers both REs associated with the PUSCH1 resource and REs associated with the PUSCH2 resource. In such calculation, because different parts of UCI are multiplexed on PUSCH1 and PUSCH2, the REs considered are different between Panel 1 and Panel 2.

As an alternative to mechanism 500, the network (e.g., network 100 of FIG. 1) that schedules the PUSCH transmission can be configured to make sure that multi-panel overlapping between PUSCH and PUCCH never happens. For example, once network 100 detects potential collisions on both Panel 1 and Panel 2 of UE 502 due to PUCCH and PUSCH overlapping, UE 502 can further configure the PUSCH transmission or the PUCCH transmission. The configuration is to ensure that the PUSCH transmission (PUSCH1 and PUSCH2) no longer overlaps in time with the PUCCH transmission (PUCCH1 and PUCCH2) in the manner of FIG. 5.

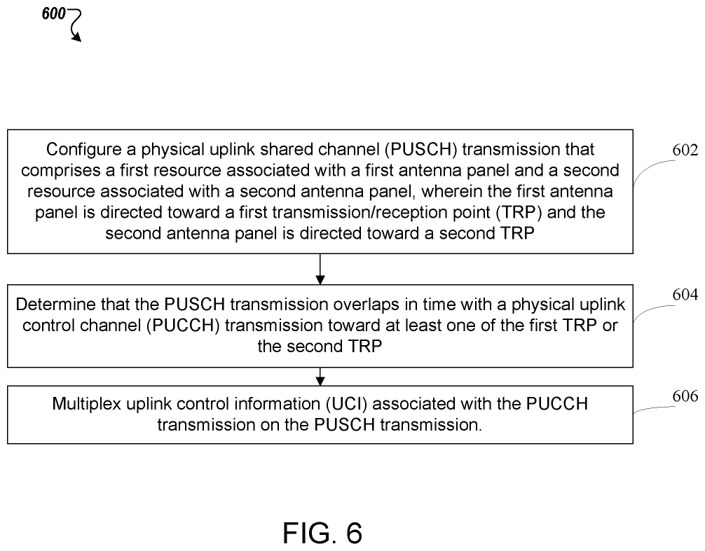

FIG. 6 illustrates a flowchart of an example method 600, according to some implementations. For clarity of presentation, the description that follows generally describes method 600 in the context of the other figures in this description. For example, method 600 can be performed by UE 102 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

At step 602, method 600 involves configuring a PUSCH transmission that comprises a first resource associated with a first antenna panel and a second resource associated with a second antenna panel. The first antenna panel is directed toward a first TRP and the second antenna panel is directed toward a second TRP.

At step 604, method 600 involves determining that the PUSCH transmission overlaps in time with a PUCCH transmission toward at least one of the first TRP or the second TRP.

At step 606, method 600 involves multiplexing UCI associated with the PUCCH transmission on the PUSCH transmission. In some implementations, the multiplexing can be performed in accordance with one or more of mechanisms 300-500 described above.

According to the description above, a multi-panel UE can properly conduct simultaneous PUSCH and PUCCH transmissions toward multiple TRPs using one or more mechanisms. Likewise, a communication network having the multi-panel UE can properly schedule the PUSCH and PUCCH transmissions toward multiple TRPs while avoiding unwanted collision of UL resources. Therefore, communication reliability and efficiency can be improved.

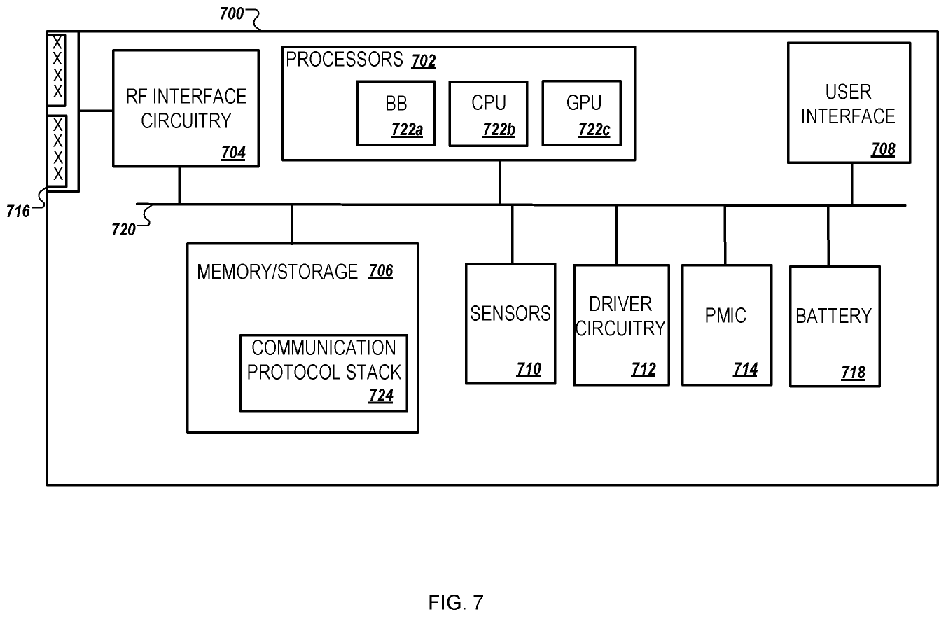

FIG. 7 illustrates a UE 700, according to some implementations. The UE 700 may be similar to and substantially interchangeable with UE 102 of FIG. 1.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein. For example, the processors 702 may configure the resources for PUSCH and PUCCH transmissions, generate modulated TB sequences, detect potential collisions between PUSCH resources and PUCCH resources, and multiplex UCI according to one of methods 300-500 described above.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc. The RF interface circuitry 704 may work with the processor 702 to perform various operations described in this disclosure, such as receiving scheduling configuration from the network and transmitting UL signals using the allocated PUSCH or PUCCH resources.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 728 and control and allow access to sensor circuitry 728, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

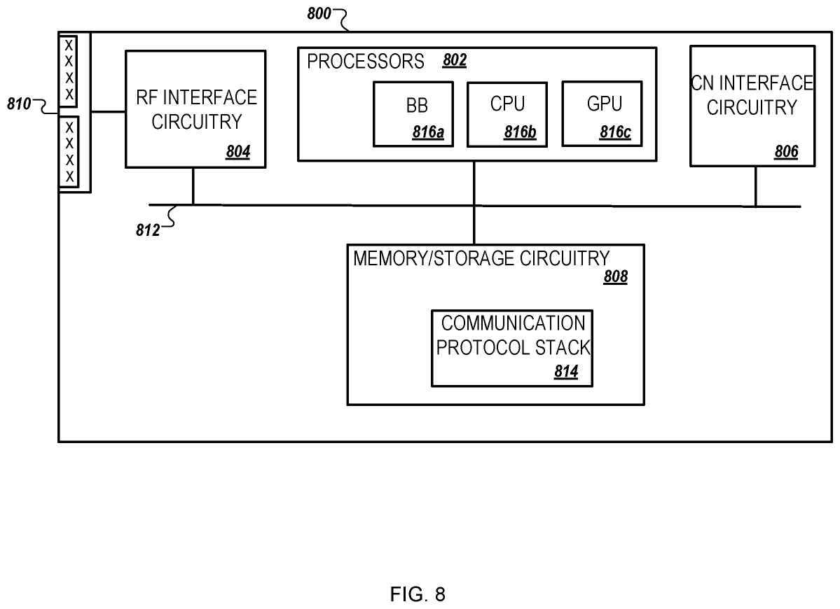

FIG. 8 illustrates an access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and antenna structure 810. The access node 800 may be configured to schedule UL transmissions and may utilize multiple TRPs to receive the UL transmissions from the UE.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, CPU 816B, and GPU 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method to be performed by a user equipment (UE), the method including: configuring a physical uplink shared channel (PUSCH) transmission that includes a first resource associated with a first antenna panel and a second resource associated with a second antenna panel, wherein the first antenna panel is directed toward a first transmission/reception point (TRP) and the second antenna panel is directed toward a second TRP; determining that the PUSCH transmission overlaps in time with a physical uplink control channel (PUCCH) transmission toward at least one of the first TRP or the second TRP; and multiplexing uplink control information (UCI) associated with the PUCCH transmission on the PUSCH transmission.

Example 2 includes the method of example 1, wherein the PUSCH transmission is configured by downlink control information (DCI) received from one of the first TRP and the second TRP.

Example 3 includes the method of example 1, wherein multiplexing the UCI on the PUSCH transmission includes: determining that the PUCCH transmission is directed toward the first TRP, and responsive to the determination, multiplexing the UCI on the first resource

Example 4 includes the method of example 3, wherein the PUCCH transmission includes a first repetition transmitted over the first resource and a second repetition transmitted over the second resource.

Example 5 includes the method of example 3, further including: calculating a code rate for UCI multiplexing based on resource elements (REs) associated with the first resource.

Example 6 includes the method of example 3, further including: calculating a code rate for UCI multiplexing based on resource elements (REs) associated with the first resource and REs associated with the second resource.

Example 7 includes the method of example 3, the method further including: multiplexing the UCI on the second resource.

Example 8 includes the method of example 7, further including: calculating a code rate for UCI multiplexing based on resource elements (REs) associated with the first resource and REs associated with the second resource.

Example 9 includes the method of example 1, wherein the PUCCH transmission is directed toward both the first TRP and the second TRP, and wherein the UCI is multiplexed on a combination of the first resource and the second resource.

Example 10 includes the method of example 9, further including: calculating a code rate for UCI multiplexing based on resource elements (REs) associated with the first resource and REs associated with the second resource.

Example 11 includes the method of example 9, further including: after determining that the PUSCH transmission overlaps in time with the PUCCH transmission, configuring the PUSCH transmission or the PUCCH transmission such that the PUSCH transmission no longer overlaps in time with the PUCCH transmission.

Example 12 includes the method of example 1, wherein the first resource and the second resource are configured for a single frequency network (SFN).

Example 13 includes the method of example 1, wherein the first resource and the second resource are spatial division multiplexed (SDM-ed).

Example 14 includes the method of example 1, wherein multiplexing the UCI on the PUSCH transmission is based on UE capability.

Example 15 includes the method of example 1, wherein multiplexing the UCI on the PUSCH transmission is based on radio resource control (RRC) signaling.

Example 16 includes one or more processors including circuitry to execute one or more instructions that, when executed, cause a user equipment (UE) to perform the method according to any of examples 1-15.

Example 17 includes a non-transitory computer-readable medium containing program instructions for causing one or more processors to perform the method according to any of examples 1-15.

Example 18 may include one or more non-transitory computer-readable media including instructions to cause an electronic device, upon execution of the instructions by one or more processors of the electronic device, to perform one or more elements of a method described in or related to any of examples 1-15, or any other method or process described herein.

Example 19 may include an apparatus including logic, modules, or circuitry to perform one or more elements of a method described in or related to any of examples 1-15, or any other method or process described herein.

Example 20 may include a method, technique, or process as described in or related to any of examples 1-15, or portions or parts thereof.

Example 21 may include an apparatus including: one or more processors and one or more computer-readable media including instructions that, when executed by the one or more processors, cause the one or more processors to perform the method, techniques, or process as described in or related to any of examples 1-15, or portions thereof.

Example 22 may include a signal as described in or related to any of examples 1-15, or portions or parts thereof.

Example 23 may include a datagram, information element, packet, frame, segment, PDU, or message as described in or related to any of examples 1-15, or portions or parts thereof, or otherwise described in the present disclosure.

Example 24 may include a signal encoded with data as described in or related to any of examples 1-15, or portions or parts thereof, or otherwise described in the present disclosure.

Example 25 may include a signal encoded with a datagram, IE, packet, frame, segment, PDU, or message as described in or related to any of examples 1-15, or portions or parts thereof, or otherwise described in the present disclosure.

Example 26 may include an electromagnetic signal carrying computer-readable instructions, wherein execution of the computer-readable instructions by one or more processors is to cause the one or more processors to perform the method, techniques, or process as described in or related to any of examples 1-15, or portions thereof.

Example 27 may include a computer program including instructions, wherein execution of the program by a processing element is to cause the processing element to carry out the method, techniques, or process as described in or related to any of examples 1-15, or portions thereof. The operations or actions performed by the instructions executed by the processing element can include the methods of any one of examples 1-15.

Example 28 may include a signal in a wireless network as shown and described herein.

Example 29 may include a method of communicating in a wireless network as shown and described herein.

Example 30 may include a system for providing wireless communication as shown and described herein. The operations or actions performed by the system can include the methods of any one of examples 1-15.

Example 31 may include a device for providing wireless communication as shown and described herein. The operations or actions performed by the device can include the methods of any one of examples 1-15.

The previously-described examples 1-15 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-15.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
configuring a physical uplink shared channel (PUSCH) transmission that comprises a first resource associated with a first antenna panel and a second resource associated with a second antenna panel, wherein the first antenna panel is directed toward a first transmission/reception point (TRP) and the second antenna panel is directed toward a second TRP;
determining that the PUSCH transmission overlaps in time with a physical uplink control channel (PUCCH) transmission toward at least one of the first TRP or the second TRP; and
multiplexing uplink control information (UCI) associated with the PUCCH transmission on the PUSCH transmission.

2. The method of claim 1, wherein the PUSCH transmission is configured by downlink control information (DCI) received from one of the first TRP and the second TRP.

3. The method of claim 1, wherein multiplexing the UCI on the PUSCH transmission comprises:
determining that the PUCCH transmission is directed toward the first TRP, and responsive to the determination, multiplexing the UCI on the first resource.

4. The method of claim 3, wherein the PUCCH transmission comprises a first repetition transmitted over the first resource and a second repetition transmitted over the second resource.

5. The method of claim 3, further comprising:
calculating a code rate for UCI multiplexing based on resource elements (REs) associated with the first resource.

6. The method of claim 3, further comprising:
calculating a code rate for UCI multiplexing based on resource elements (REs) associated with the first resource and REs associated with the second resource.

7. The method of claim 3, the method further comprising:
multiplexing the UCI on the second resource.

8. The method of claim 7, further comprising:
calculating a code rate for UCI multiplexing based on resource elements (REs) associated with the first resource and REs associated with the second resource.

9. The method of claim 1,
wherein the PUCCH transmission is directed toward both the first TRP and the second TRP, and
wherein the UCI is multiplexed on a combination of the first resource and the second resource.

10. The method of claim 9, further comprising:
calculating a code rate for UCI multiplexing based on resource elements (REs) associated with the first resource and REs associated with the second resource.

11. The method of claim 9, further comprising:
after determining that the PUSCH transmission overlaps in time with the PUCCH transmission, configuring the PUSCH transmission or the PUCCH transmission such that the PUSCH transmission no longer overlaps in time with the PUCCH transmission.

12. The method of claim 1, wherein the first resource and the second resource are configured for a single frequency network (SFN).

13. The method of claim 1, wherein the first resource and the second resource are spatial division multiplexed (SDM-ed).

14. The method of claim 1, wherein multiplexing the UCI on the PUSCH transmission is based on UE capability.

15. The method of claim 1, wherein multiplexing the UCI on the PUSCH transmission is based on radio resource control (RRC) signaling.

16.-17. (canceled)

18. The method of claim 1, wherein multiplexing the UCI on the PUSCH transmission comprises:
determining that the PUCCH transmission is associated a same resource as the first resource of the PUSCH transmission; and
responsive to the determination, multiplexing the UCI on the first resource of the PUSCH transmission.

19. One or more processors configured to, when executing instructions stored in memory, perform operations comprising:
configuring a physical uplink shared channel (PUSCH) transmission that comprises a first resource associated with a first antenna panel and a second resource associated with a second antenna panel, wherein the first antenna panel is directed toward a first transmission/reception point (TRP) and the second antenna panel is directed toward a second TRP;
determining that the PUSCH transmission overlaps in time with a physical uplink control channel (PUCCH) transmission toward at least one of the first TRP or the second TRP; and
multiplexing uplink control information (UCI) associated with the PUCCH transmission on the PUSCH transmission.

20. The one or more processors of claim 19, wherein multiplexing the UCI on the PUSCH transmission comprises:
determining that the PUCCH transmission is associated a same resource as the first resource of the PUSCH transmission; and
responsive to the determination, multiplexing the UCI on the first resource of the PUSCH transmission.

21. A non-transitory computer-readable medium storing instructions executable by one or more processors to perform operations comprising:
configuring a physical uplink shared channel (PUSCH) transmission that comprises a first resource associated with a first antenna panel and a second resource associated with a second antenna panel, wherein the first antenna panel is directed toward a first transmission/reception point (TRP) and the second antenna panel is directed toward a second TRP;
determining that the PUSCH transmission overlaps in time with a physical uplink control channel (PUCCH) transmission toward at least one of the first TRP or the second TRP; and
multiplexing uplink control information (UCI) associated with the PUCCH transmission on the PUSCH transmission.

22. The non-transitory computer-readable medium of claim 21, wherein multiplexing the UCI on the PUSCH transmission comprises:
determining that the PUCCH transmission is associated a same resource as the first resource of the PUSCH transmission; and
responsive to the determination, multiplexing the UCI on the first resource of the PUSCH transmission.
